(19) United States
(12) Patent Application Publication
(10) Pub. No.: US 2005/0228926 A1
(43) Pub. Date: Oct. 13, 2005

(54) Virtual-bus interface and associated system and method

(76) Inventors: Zachary Steven Smith, Fort Collins, CO (US); John Warren Maly, Laporte, CO (US); Ryan Clarence Thompson, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/818,389

(22) Filed: Apr. 5, 2004

(51) Int. Cl. G06F 13/42

(52) U.S. Cl. 710/305

(57) ABSTRACT

One exemplary system embodiment includes a detection logic that facilitates identifying that a point-to-point transaction is a transaction that is not micro-architecturally implemented and a tracking logic that facilitates tracking the transaction and related packets through the virtual bus interface and that also facilitates producing an error data associated with the non-micro-architecturally implemented transaction.

### BACKGROUND

Computer systems may include computer components that are operably connected together. These computer components may be operably connected by, for example, a bus and/or via a port(s) into point-to-point (P2P) links. Components that are operably connected by a bus typically “listen” to substantially every request placed on the bus, “hear” substantially every response on the bus, and try to communicate over the bus. To facilitate listening, hearing, communicating, and the like, various bus communication techniques, timings, protocols, and so on, have evolved. Thus, a transaction like a data read in a bus model system may include producing and monitoring various phases (e.g., arbitration, requests, snooping, data) and sending/receiving various signals during these phases.

Computer components that are operably connected by P2P links operate substantially differently than those connected by a bus. Requests and responses are routed more exclusively between sending and receiving components. Thus, less than all the operably connected computer components may encounter packets associated with a transaction. Packets may be broken up into smaller units known as flits. A transaction like a data read may be performed by sending and receiving packets and/or flits between various source and destination components. The actions taken to send, receive, and/or route packets to perform a P2P transaction may be different than the actions taken to perform a corresponding bus model transaction.

In environments like processor verification and hybrid multi-processing, some components may be connected by a bus like a front-side bus (FSB) and other components may be connected by P2P links. FSB connected components perform certain actions in certain ways. For example, messages intended for one component may be broadcast on the FSB, viewed by all components operably connected to the FSB, and acted on by target components. P2P link connected components perform certain actions in certain other ways. For example, packets may be transmitted between specific components with a crossbar “traffic cop” responsible for directing packets/flits. Since both FSB connections and P2P connections have strengths and weaknesses it is not surprising that some computer systems are FSB connected while others are P2P configured. In some examples, a multiprocessor system or other large system may even include components that are connected using both methods.

Over the years, tools have developed for designing, analyzing, testing, and so on, systems that use an FSB. Other tools have developed for designing, analyzing, testing, and so on, systems that use P2P links. Since the two systems are fundamentally different, a tool known as a virtual bus interface (VBI) developed to facilitate correlating and/or comparing results from the different tools. A VBI facilitates producing bus-type transactions from P2P transactions. This may in turn facilitate communication between systems employing a bus model and systems employing a P2P link model. But, as described above, the conceptual and logical structure of P2P transactions differs fundamentally from that of bus transactions.

A VBI may be used in processor design to facilitate correlating and/or verifying simulation tool actions. A first processor design tool like a bus model register transfer language simulation tool may be available. A second processor design tool like a higher level language P2P link model simulator may also be available. A VBI may facilitate comparing the outputs of the two processor design tools. For example, transactions from the P2P linked model tool can be used as inputs to a VBI that will produce corresponding bus model transactions. Thus, transactions occurring in the P2P model tool can be compared to transactions occurring in the bus model tool, providing greater confidence in simulation results.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example bus model configuration of computer components.

FIG. 2 illustrates an example P2P model configuration of computer components.

FIG. 3 illustrates an example environment in which a virtual bus interface may handle non-micro-architecturally implemented transactions.

FIG. 4 illustrates an example system for handling non-micro-architecturally implemented transactions.

FIG. 5 illustrates an example message flow associated with a VBI.

FIG. 6 illustrates an example VBI configured to handle non-micro-architecturally implemented transactions.

FIG. 7 illustrates an example method for handling non-micro-architecturally implemented transactions.

FIG. 8 illustrates an example computing environment in which example systems and methods illustrated herein can operate.

FIG. 9 illustrates an example application programming interface (API).

### DETAILED DESCRIPTION

Some example systems and methods described herein concern a VBI that produces bus-type transactions from P2P transactions handling non-micro-architecturally implemented transactions. A processor may attempt to communicate with other processors, memories, and so on, via a P2P link. A core protocol engine (CPE) may function as an interface between the processor and the P2P link. Micro-architectural decisions concerning the processor and/or system associated with the processor, may create a situation where some of the possible P2P transactions that can be handled by a P2P link should not be emitted by the CPE and thus should not exist on the P2P link. If these types of transactions are emitted by the CPE, then a reconfigured VBI that intercepts transactions initially intended for a P2P link may handle these non-micro-architecturally implemented transactions. Additionally, transactions including non-implemented transactions may arrive at the VBI from other locations like other agents on a P2P network, other RTL cores, other RTL devices, a simulated agent, and so on. Non-micro-architecturally implemented transactions will be referred to as “non-implemented transactions”.

In a system designed to communicate via a point-to-point protocol where a VBI processes the point-to-point protocol transactions and/or packets into bus-model transactions, there may be mismatches between the types of transactions and/or packets that the VBI can handle, the types of transactions and/or packets that the VBI is expecting to handle, the types of transactions and/or packets that the system is configured to produce, and the types of transactions and/or packets that the system actually produces. For example, a P2P protocol specification may list twenty transaction types while a system being developed may only have implemented twelve of the twenty transaction types. Thus, a conventional VBI may be configured to only process the twelve implemented types. If a conventional VBI processing P2P transactions into bus-type transactions encounters one of the eight transaction types that are not implemented it may enter an error state or not process the transaction correctly.

Thus, example systems and methods described herein facilitate reconfiguring and/or working with a VBI to process the non-implemented transactions as errors. Errors may arise for various reasons. For example, a transaction may be injected into a test run to see how a processor, CPE, or P2P link responds, an engineer may make a mental error and program a processor to produce a transaction that it is physically incapable of producing, bits may get damaged and thus a 0 may be changed to 1 causing a transaction type to be changed, for example, from 0×A1 (implemented) to 0×A0 (not implemented), and the like. While three situations are described, it is to be appreciated that other situations may lead to non-implemented transactions being received by a VBI. Example systems and methods facilitate a VBI identifying a non-implemented transaction, establishing completion criteria for it, processing it and tracking it through the VBI, and then, when the completion criteria are satisfied, taking actions like, reporting out an error and releasing a transaction identifier for reuse.

The following includes definitions of selected terms employed herein. The definitions include various examples that fall within the scope of a term. The examples are not intended to be limiting. Both singular and plural forms of terms may be within the definitions.

As used in this application, the term “computer component” refers to a computer-related entity, either hardware, firmware, software, or a combination thereof. Computer components can include, for example, a process running on a processor, a processor, an object, an executable, a thread of execution, a program, a computer, and so on. Computer components may be localized on one computer and/or distributed between two or more computers.

“Computer-readable medium”, as used herein, refers to a medium that participates in directly or indirectly providing signals, instructions and/or data to a computer component. A computer-readable medium may take forms like non-volatile media, volatile media, transmission media, and the like. Non-volatile media may include, for example, optical or magnetic disks. Volatile media may include, for example, optical or magnetic disks, dynamic memory, and so on. Transmission media may include, for example, coaxial cables, copper wire, and fiber optic cables. Transmission media may also take the form of electromagnetic radiation, like that generated during radio-wave and infra-red data communications, or take the form of one or more groups of signals. Common forms of a computer-readable medium include, floppy disks, hard disks, magnetic tapes, CD-ROMs, RAMs, ROMs, EPROMs, other memory chips or cards, memory sticks, carrier waves/pulses, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations thereof that perform a function(s) or an action(s), and/or that cause a function or action from another logic, method, and/or system. For example, a logic may include a software controlled microprocessor, discrete logic like an application specific integrated circuit (ASIC), a programmed logic device, a memory device containing instructions, and so on. A logic may include one or more gates, combinations of gates, or other circuit components. A logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected” or “operably connectable”, is one in which signals, physical communications, and/or logical communications may be sent and/or received. Typically, an operable connection includes a physical interface, an electrical interface, and/or a data interface, but an operable connection may include differing combinations of these or other types of connections sufficient to allow operable control. For example, two entities can be operably connected by being able to communicate signals to each other directly or through one or more intermediate computer components, logics, and so on. Logical and/or physical communication channels can be used to create an operable connection.

“Signal”, as used herein, includes but is not limited to an electrical or optical signal(s), analog or digital signal(s), data, computer or processor instruction(s), message(s), bit or bit stream, or other means that can be received, transmitted and/or detected.

“Software”, as used herein, refers to computer or processor instructions that can be read, interpreted, compiled, and/or executed to cause a computer, processor, or other electronic device to perform an action(s) and/or behave in a desired manner. The instructions may be embodied in various forms like routines, algorithms, modules, methods, threads, and/or programs including separate applications or instructions from dynamically linked libraries. Software may be implemented in a variety of executable and/or loadable forms including, but not limited to, a stand-alone program, a function call (local and/or remote), a servelet, an applet, instructions stored in a memory, part of an operating system or other types of executable instructions. Software can be located in one logic and/or distributed between two or more communicating, co-operating, and/or parallel processing logics and thus can be loaded and/or executed in serial, parallel, massively parallel and other manners.

Suitable software for implementing various components of example systems and methods described herein include programming languages and tools like Java, Pascal, C#, C++, C, CGI, Perl, SQL, APIs, SDKs, assembly, firmware, microcode, and so on. Software, whether an entire system or a component of a system, may be embodied as an article of manufacture and maintained or provided as part of a computer-readable medium as defined previously. Software may be transmitted as signals over a network or other communication medium. Thus, in one example, a computer-readable medium takes the form of signals that represent software as it is downloaded from a web server to a user. In another example, the computer-readable medium takes the form of software as it is maintained on the web server.

Some portions of the following detailed description are presented in terms of algorithms and symbolic representations of operations on data bits in a memory. These algorithmic descriptions and symbolic representations are means used by those skilled in the art to convey the substance of their work to others. An algorithm is here, and generally, conceived to be a sequence of operations that produce a tangible, concrete, real-world result. The operations may include physical manipulations of physical items. The physical quantities may take the form of electrical or magnetic signals capable of being stored, transferred, combined, compared, and otherwise manipulated in a logic, computer memory, and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. It is appreciated that throughout the description, terms like processing, computing, calculating, determining, displaying, or the like, refer to actions and processes of a computer component, logic, processor, or similar electronic device that manipulates and transforms data represented as physical (electronic) quantities.

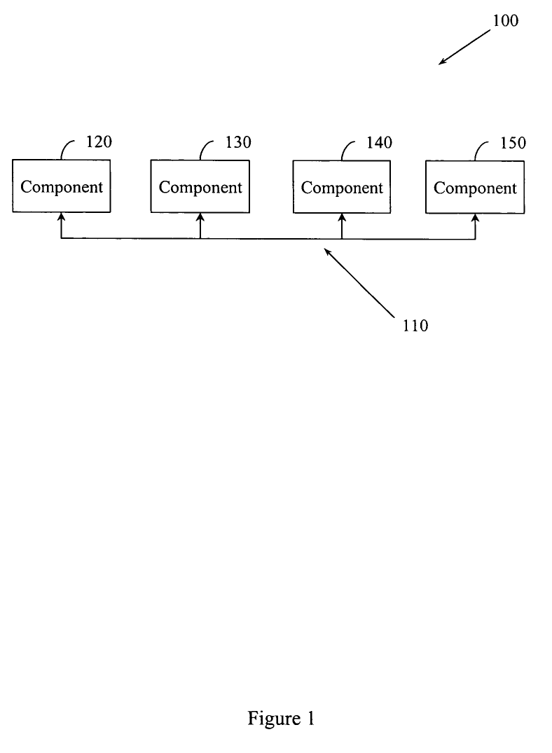

FIG. 1 illustrates an example bus model configuration 100 of computer components. A bus 110, like a front-side bus, may connect components like component 120, 130, 140, and 150. The components may be, for example, processors in a multiprocessor system, memories, caches, and so on. While four components are illustrated, it is to be appreciated that a greater and/or lesser number of components may be connected. A transaction on bus 110 may include, for example, two fundamental parts like a request part and a response part. The request part may transmit a request to be serviced and the response part may complete or defer the transaction. Thus, a transaction may be thought of as a set of bus activities that relate to a single bus operation like a read or write. A transaction may proceed through multiple phases like an arbitration phase, a request phase, an error phase, a snoop phase, a response phase, a data phase, and so on. A communication between a first component (e.g., 120) and a second component (e.g., 130) will be heard by substantially all the components (e.g., 120, 130, 140, 150) operably connected by the bus 110.

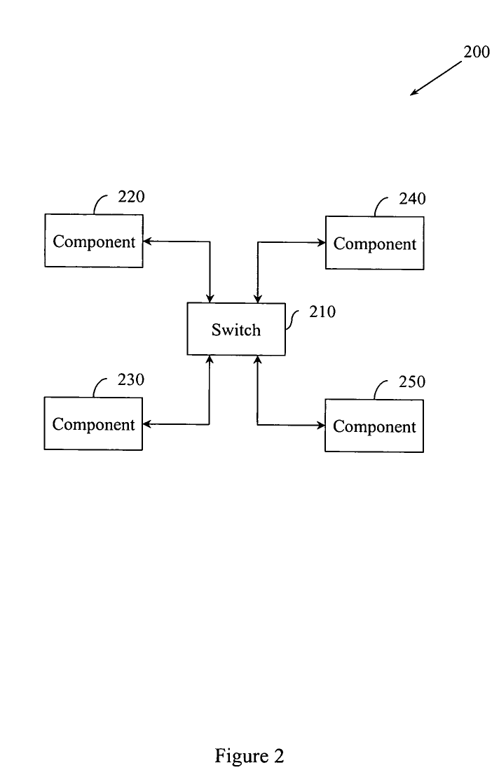

FIG. 2 illustrates an example P2P model configuration 200 of computer components. A switch 210 like a crossbar switch may connect components like components 220, 230, 240, and 250. Once again, while four components are illustrated, it is to be appreciated that a switch(es) can connect a greater and/or lesser number of components in a P2P linked system. Requests from a first component (e.g., 220) may be routed through the switch 210 to arrive at a second component (e.g., 230). Components other than the first and second component, like components 240 and 250 may not be aware that the communication between the first and second component occurred. As described above, transactions are fundamentally different in the bus-model and the point-to-point model. For example, while transactions in the point-to-point model include sets of packets, transactions in a bus-model do not have packets.

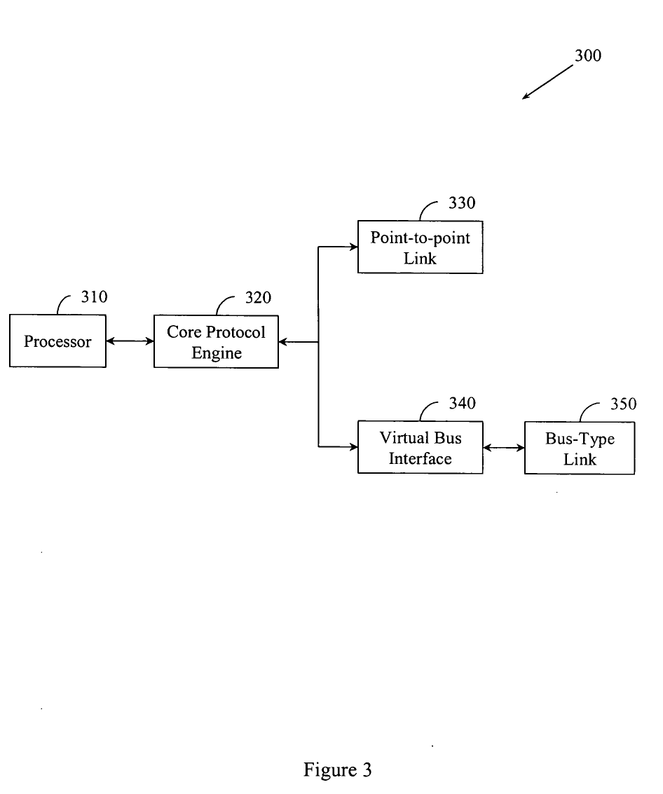

FIG. 3 illustrates a portion 300 of a system in which a processor 310 uses a core protocol engine 320 as an interface to other computer components, and so on. In one example, the core protocol engine 320 may be an interface to a point-to-point link 330. In another example, the core protocol engine 320 may be a link to a VBI 340 which is in turn an interface to a bus-type link 350. Based on micro-architectural decisions relating to the processor 310, some transactions that are part of a protocol implemented by the point-to-point link 330 should not be presented to the core protocol engine 320 by the processor 310. Thus, the core protocol engine 320 should not present such transactions to the virtual bus interface 340 or the point-to-point link 330. While the point-to-point link 330 may handle the unexpected transaction because the transaction is part of the protocol implemented by the point-to-point link 330, a conventional virtual bus interface 340 may not be so successful.

A conventional virtual bus interface 340 may be configured to only process transactions that the processor 310 should produce based on the micro-architectural decisions. Thus, example systems and methods described herein concern interacting with and/or reconfiguring the virtual bus interface 340 to handle non-micro-architecturally implemented transactions. Additionally, the virtual bus interface 340 may encounter transactions destined for processor 310 or CPE 320 including non-implemented transactions that may arrive from other locations like other agents on a P2P network, other RTL cores, other RTL devices, a simulated agent, and so on.

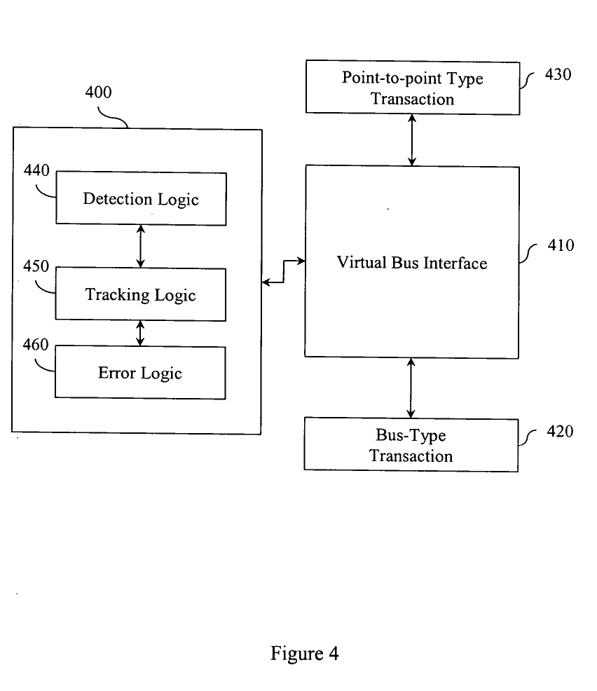

FIG. 4 illustrates an example system 400 that facilitates a VBI 410 handling non-micro-architecturally implemented transactions. The system 400 may be configured to interact with VBI 410, which is configured to produce a bus-type transaction 420 from a P2P transaction 430. The system 400 may include a detection logic 440 that is configured to determine whether the P2P transaction is a non-implemented transaction. For example, P2P transactions that should not be emitted by a core protocol engine and that are received as non-implemented transactions in the system 400 and/or virtual bus interface 410 may be identified and then tracked to completion in the system 400. A P2P transaction and/or packet associated therewith may be identified as being a non-implemented transaction by, for example, examining a transaction type, a packet type, a transaction identifier, and the like. The transaction type and/or packet type may be compared, for example, to a list of implemented transactions, a table of implemented transactions, and so on, to determine whether a processor, system, and/or CPE should be emitting that type of transaction and/or packet. The transaction identifier may be compared, for example, to a list, table, or so on of transaction identifiers associated with transactions previously identified as being non-implemented transactions. Tracking to completion may include, for example, monitoring the virtual bus interface 410 as it receives and assembles packets associated with a transaction.

A tracking logic 450 may encode completion criteria for non-implemented transactions similar to how completion criteria are encoded for implemented transactions. Tracking the transaction to completion facilitates actions like reusing transaction identifiers and thus reducing VBI 410 and/or initiating agent resource consumption, making a state machine associated with a VBI 410 more complete and more efficient, and so on. Similarly, tracking the transaction to completion facilitates preventing a VBI transaction tracking logic from entering an unknown state that could lead to VBI 410 resources (e.g., time, processor cycles, memory) being consumed to recover from the unknown state.

In one example, when a non-implemented transaction is recognized the tracking logic 450 may mark the transaction as being not implemented and subsequently, based on the marking, control the VBI 410 to neither produce a bus model transaction nor allow reuse of a transaction identifier allocated to the non-implemented transaction until the non-implemented transaction has been tracked to completion. In another example, the tracking logic 450 may update a data structure or store a value in a data store to indicate that the non-implemented transaction is to be tracked. Subsequent packets associated with the non-implemented transaction may satisfy remaining semantic requirements for a transaction and thus cause the non-implemented transaction to logically proceed through the VBI 410 transaction tracking logic and/or the tracking logic 450. This tracking facilitates VBI 410 properly processing subsequently received packets that are related to the non-implemented transaction as well as other packets not related to the non-implemented transaction. This in turn may facilitate the reuse of transaction identifiers and more efficient VBI 410 processing.

Non-implemented transactions that are tracked may be reported out as errors by, for example, producing error messages, manipulating values stored in computer memory, generating an error signal, and the like. Thus, the system 400 may also include an error logic 460 that facilitates producing error signals, error data and/or messages associated with the error transaction. In one example the error signals, data, and/or messages may be reported directly from the error logic to a file, monitor, system, and so on, while in another example they may be reported through the virtual bus interface 410.

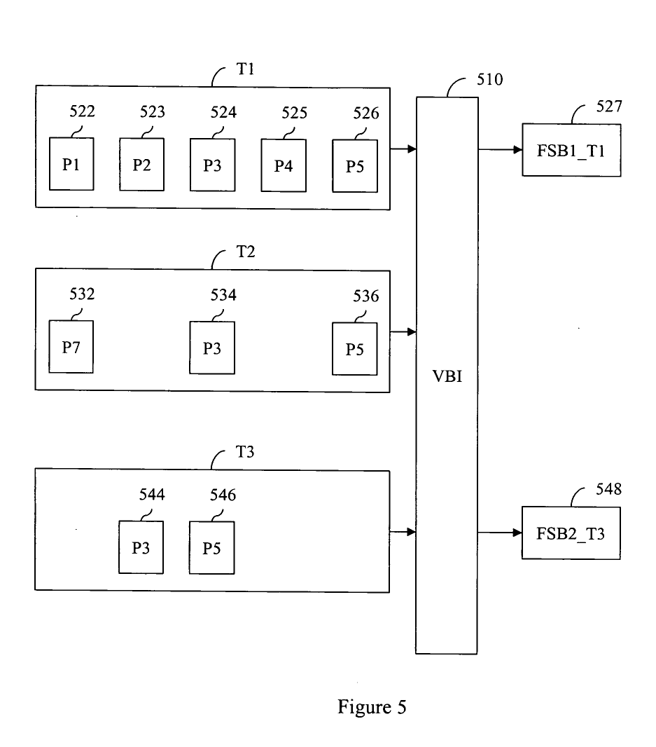

FIG. 5 illustrates an example message flow associated with a VBI 510 that is configured to handle non-micro-architecturally implemented transactions. The VBI 510 may be configured to track, for example, non-implemented transactions, P2P transactions that a user specifies are error transactions, and so on.

A first transaction T1, which includes a set of packets P1 522, P2 523, P3 524, P4 525, and P5 526 may be presented to the VBI 510. The nomenclature Px refers to a packet P with an identifier x that facilitates identifying a packet type. For example, a packet P1 may indicate that the packet is a header packet for a read transaction. Similarly, a packet P7 may indicate that the packet is a header packet for a P2P routing request. The set of packets in transaction T1 may describe a valid, implemented P2P transaction and thus may lead to VBI 510 producing a first front-side bus transaction FSB1_T1. A second transaction T2, which includes a set of packets P7 532, P3 534, and P5 536 may similarly be presented to VBI 510. Transaction T2 may be a transaction that is not supposed to be presented to VBI 510. For example, in a development environment, a prototype processor may not have implemented the functionality that would produce the packets in T2. For example, transactions that begin with a packet P7 may be identifiable as non-implemented transactions. However, VBI 510 may be configured to do more than just ignore these non-implemented transactions. Rather than simply ignoring packet P7 532, VBI 510 may take actions like marking the transaction T2 as a non-implemented transaction, updating a data store or data structure to indicate that transaction T2 is a non-implemented transaction, and so on. After taking the action(s) to facilitate identifying that packets P3 534 and P5 536 belong to transaction T2, which is a non-implemented transaction, VBI 510 may continue to process transaction T2 to completion by receiving and processing packets P3 534 and P5 536. Thus, rather than receiving packet P3 534 and having it appear to not belong to a current transaction, which could trigger processing of a new transaction, the VBI 510 will be able to correctly process transaction T2 and account for packets P3 534 and P5 536.

Tracking and processing error transactions to completion facilitates avoiding a problem that could occur if, for example, transaction T2 was not correctly handled (e.g., packet P7 532 simple discarded) and then packets P3 534 and P5 536 arrived. As can be seen by VBI 510 processing transaction T3 into a related bus transaction FSB2_T3 548, the packets P3 544 and P5 546 form a valid P2P transaction. If packet P7 532 were simply discarded, and if packets P3 534 and P5 536 subsequently arrived and were not handled as part of transaction T2, then an “extra” transaction could be produced by the VBI 510.

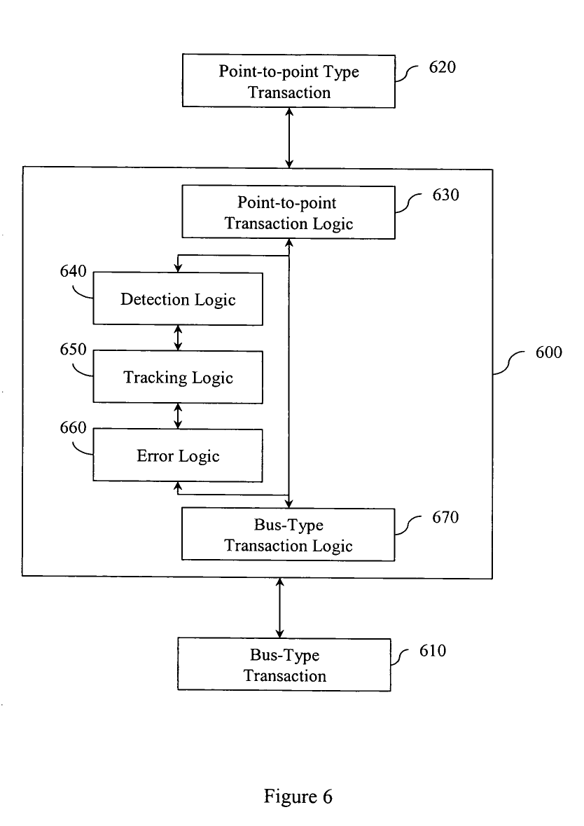

FIG. 6 illustrates a VBI 600 that is configured to handle non-micro-architecturally implemented transactions. The VBI 600 may produce a bus-type transaction 610 from a P2P type transaction 620. Thus, the VBI 600 may include a P2P transaction logic 630 configured to process a packet associated with the P2P transaction 620. The packet may include an identifier that facilitates detennining whether the packet is part of a non-implemented transaction. Thus the VBI 600 may include a detection logic 640 configured to detect that a packet associated with P2P transaction 620 identifies the transaction as a non-implemented transaction. A P2P transaction and/or packet associated therewith may be identified as being a non-implemented transaction by, for example, examining a transaction type, a packet type, a transaction identifier, and the like. The transaction type and/or packet type may be compared, for example, to a list of implemented transactions, a table of implemented transactions, and so on, to determine whether a processor, system, and/or CPE should be emitting that type of transaction and/or packet. The transaction identifier may be compared, for example, to a list, table, or so on of transaction identifiers associated with transactions previously identified as being non-implemented transactions.

VBI 600 may also include a bus-type transaction logic 670 that is configured to selectively produce the bus-type transaction 610 from the P2P transaction 620 when the P2P transaction 620 is an implemented transaction type. To facilitate correctly handling packets associated with a non-implemented transaction, VBI 600 may include a tracking logic 650 that is configured to track the non-implemented transaction and its packets/flits as they are received by the P2P transaction logic 630. VBI 600 may also include an error logic 660 that is configured to facilitate selectively producing error data and/or messages related to a non-implemented transaction.

The detection logic 630 and the error logic 660 may coordinate their activities concerning tracking, handling and reporting on non-implemented transactions using various methods. For example, upon detecting that P2P transaction 620 is a non-implemented transaction, the detection logic 630 may take actions like, storing a value that uniquely identifies the non-implemented transaction in a data structure associated with VBI 600, storing a value that uniquely identifies the non-implemented transaction in a data store associated with VBI 600, and/or marking the transaction as an “error” transaction. Then the error logic 660 may control producing error data and/or messages based on the value(s) and/or marking.

Tracking logic 650 may examine a reusable transaction identifier provided by an initiating agent to facilitate tracking a transaction as it is processed by VBI 600. The reusable transaction identifier may facilitate relating packets to transactions with which they are associated. In one example, a transaction identifier may be stored in each packet processed by VBI 600. However, there may be a finite set of transaction identifiers available. For example, a four bit field may be allocated for storing a transaction identifier, and thus only sixteen transaction identifiers may be available. With only sixteen transaction identifiers available, an initiating agent may need to efficiently reuse transaction identifiers.

Efficiently handling actions like identifying when a transaction is complete and identifying when packets associated with a new transaction are being received may benefit transaction identifier reuse and thus VBI 600 and/or initiating agent correctness and efficiency. By handling non-implemented transactions, situations where a transaction identifier may not be reusable may be avoided. For example, a first packet may be received by VBI 600. VBI 600 may determine that the packet is the first packet in a new transaction. However, if the packet is a packet that a CPE should not have emitted or the packet is associated with a non-implemented transaction then conventionally, subsequent related packets that arrive may not be handled properly and the transaction may not complete. Additionally, state machine logic in VBI 600 may not correctly handle the packets and/or transaction. Therefore, the reusable transaction identifier that was allocated to the transaction may conventionally be unavailable for reuse by the initiating agent longer than is the case when the transaction is processed by a reconfigured VBI that is able to handle non-implemented transactions.

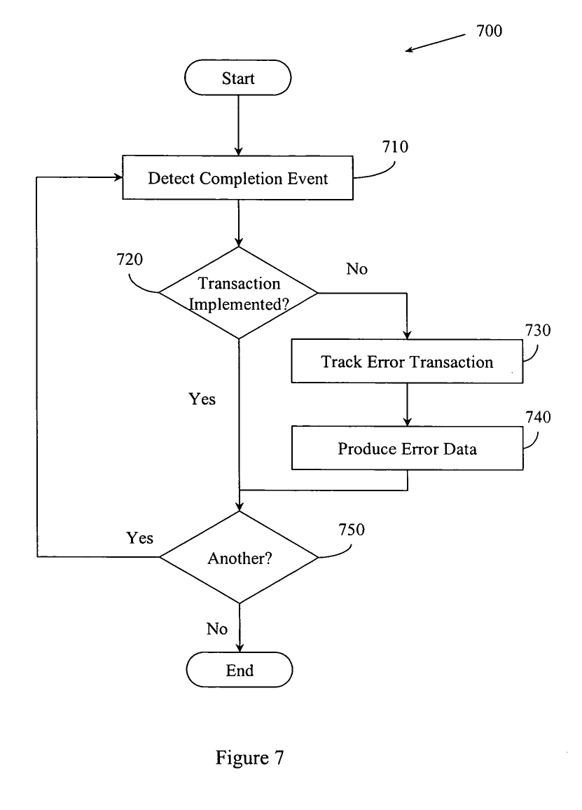

Example methods may be better appreciated with reference to the flow diagram of FIG. 7. While for purposes of simplicity of explanation, the example methodology is described as a series of actions, it is to be appreciated that the methodology is not limited by the order of the actions, as some may occur in different orders and/or concurrently with others. Moreover, less than all the illustrated actions may be required to implement an example methodology. Furthermore, additional and/or alternative methodologies can employ additional, not illustrated actions.

In the flow diagram, blocks denote actions that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be appreciated that the actions may be implemented using various programming approaches like machine language, procedural, object oriented and/or artificial intelligence techniques.

FIG. 7 illustrates an example method 700 to facilitate a VBI handling non-micro-architecturally-implemented transactions. The method 700 may include, at 710, detecting a completion event associated with a P2P transaction and/or packet being received in a VBI. As described above, transactions may arrive at the VBI from locations like, a core protocol engine, agents on a P2P network, RTL cores, RTL devices, a simulated agent, and so on. Once the completion event has been detected the method 700 may make a determination at 720 concerning whether the received P2P transaction is an implemented transaction. If the determination at 720 is No, then at 730 the method 700 may include selectively tracking the transaction to completion. To facilitate tracking a transaction that is not implemented, the method 700 may cause actions to occur like, manipulating a memory location to identify the P2P transaction to the VBI as non-implemented transaction, marking the P2P transaction to identify it as a non-implemented transaction, allocating a transaction identifier to the non-implemented transaction, and so on. Thus, as a transaction proceeds through a VBI, various logics in the VBI may be able to reference the manipulated memory location and/or the transaction marking to determine how to handle the error transaction. Similarly, the transaction identifier may facilitate logically advancing a non-implemented transaction through a VBI state machine.

The method 700 may also include, at 740, selectively producing error data associated with processing the non-implemented transaction. At 750, a determination is made concerning whether there is another transaction and/or packet to process. If the determination is No, then processing can conclude, otherwise processing can return to 710.

While FIG. 7 illustrates various actions occurring in serial, it is to be appreciated that various actions illustrated in FIG. 7 could occur substantially in parallel. By way of illustration, a first process could detect a completion event, a second process could determine whether a transaction is an implemented transaction, and a third process could facilitate producing error data and/or messages associated with the tracked transaction by, for example, manipulating memory, marking transactions, and so on. While three processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method that includes detecting a completion event associated with a point-to-point transaction being received in a virtual bus interface and determining whether the point-to-point transaction is an implemented transaction. Determining whether the point-to-point transaction is an implemented transaction may include comparing a transaction identifier to a set of transaction identifiers previously identified as being associated with non-implemented transaction types. The method may also include selectively tracking the point-to-point transaction through the virtual bus interface by establishing a set of semantic phase completion criteria including an ultimate completion criteria and monitoring the progress of the point-to-point transaction through the set of semantic phase completion criteria to the ultimate completion criteria. The method may also include selectively producing error signals, error codes, error messages, and so on, associated with processing a non-implemented transaction.

While the above method is described being stored on a computer-readable medium, it is to be appreciated that other example methods described herein can also be stored on a computer-readable medium.

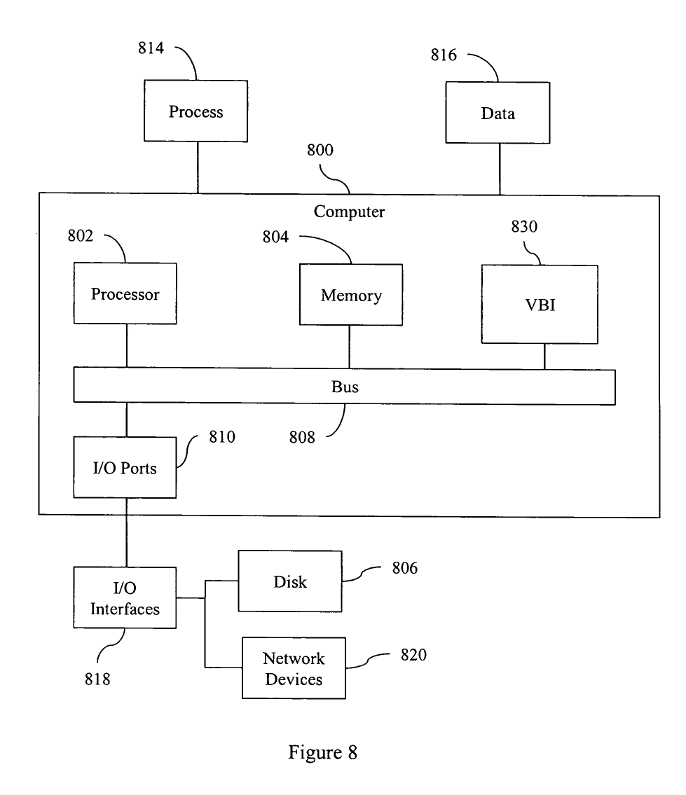

FIG. 8 illustrates a computer 800 that includes a processor 802, a memory 804, and input/output ports 810 operably connected by a bus 808. In one example, the computer 800 may include a VBI 830 configured to facilitate converting P2P transactions into bus-type transactions. The VBI 830 may be reconfigured according to the systems and methods described herein to facilitate handling non-micro-architecturally implemented transactions. Whether implemented as hardware, firmware, software, and/or combinations thereof, the VBI 830 may provide means for determining whether a packet associated with a point-to-point transaction received by a virtual bus interface identifies the point-to-point transaction as a non-implemented transaction, means for identifying a packet associated with a non-implemented transaction to the virtual bus interface to facilitate processing a subsequently received packet associated with the non-implemented transaction, and means for tracking the non-implemented transaction as it processed by the virtual bus interface.

The processor 802 can be a variety of various processors including dual microprocessor and other multi-processor architectures. The memory 804 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to the computer 800 via, for example, an input/output interface (e.g., card, device) 818 and an input/output port 810. The disk 806 can include, but is not limited to, devices like a magnetic disk drive, a solid state disk drive, a floppy disk drive, a tape drive, a Zip drive, a flash memory card, and/or a memory stick. Furthermore, the disk 806 can include optical drives like a CD-ROM, a CD recordable drive (CD-R drive), a CD rewriteable drive (CD-RW drive), and/or a digital video ROM drive (DVD ROM). The memory 804 can store processes 814 and/or data 816, for example. The disk 806 and/or memory 804 can store an operating system that controls and allocates resources of the computer 800.

The bus 808 can be a single internal bus interconnect architecture and/or other bus or mesh architectures. While a single bus is illustrated, it is to be appreciated that computer 800 may communicate with various devices, logics, and peripherals using other busses that are not illustrated (e.g., PCIE, SATA, Infiniband, 1394, USB, Ethernet). The bus 808 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 800 may interact with input/output devices via i/o interfaces 818 and input/output ports 810. Input/output devices can include, but are not limited to, a keyboard, a microphone, a pointing and selection device, cameras, video cards, displays, disk 806, network devices 820, and the like. The input/output ports 810 can include but are not limited to, serial ports, parallel ports, and USB ports.

The computer 800 can operate in a network environment and thus may be connected to network devices 820 via the i/o devices 818, and/or the i/o ports 810. Through the network devices 820, the computer 800 may interact with a network. Through the network, the computer 800 may be logically connected to remote computers. The networks with which the computer 800 may interact include, but are not limited to, a local area network (LAN), a wide area network (WAN), and other networks. The network devices 820 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 820 can connect to WAN technologies including, but not limited to, point to point links, circuit switching networks like integrated services digital networks (ISDN), packet switching networks, and digital subscriber lines (DSL).

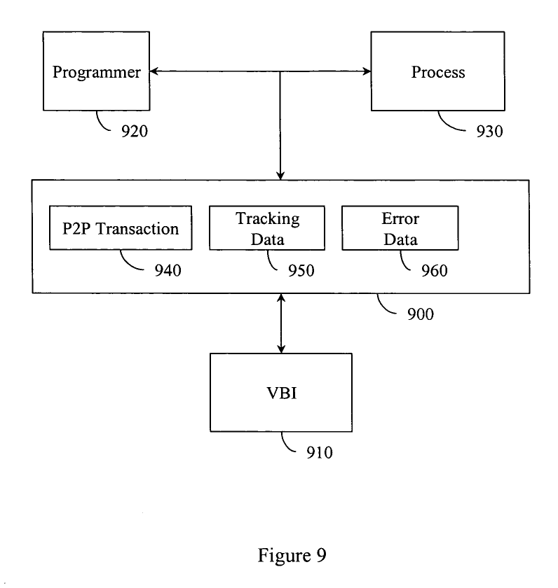

Referring now to FIG. 9, an application programming interface (API) 900 is illustrated providing access to a VBI 910. The API 900 can be employed, for example, by a programmer 920 and/or a process 930 to gain access to processing performed by the VBI 910. For example, a programmer 920 can write a program to access the VBI 910 (e.g., invoke its operation, monitor its operation, control its operation) where writing the program is facilitated by the presence of the API 900. Rather than programmer 920 having to understand the internals of the VBI 910, the programmer 920 merely has to learn the interface to the VBI 910. This facilitates encapsulating the functionality of the VBI 910 while exposing that functionality.

Similarly, the API 900 can be employed to provide data values to the VBI 910 and/or retrieve data values from the VBI 910. For example, a process 930 that receives P2P transactions can provide a P2P transaction to the system 910 via the API 900 by using a call provided in the API 900. Thus, in one example of the API 900, a set of application programming interfaces can be stored on a computer-readable medium. The interfaces can be employed by a programmer 920, computer component, logic, process 930, and so on, to gain access to VBI 910. The interfaces can include, but are not limited to, a first interface 940 that communicates a P2P transaction (e.g., a set of packets, a set of flits), a second interface 950 that communicates a tracking data (e.g., marking, flag, semaphore) that facilitates tracking a non-implemented transaction, and a third interface 960 that communicates an error data that facilitates producing an error message, error log entry, VBI transaction tracking control data, and the like related to the non-implemented transaction.

While example systems, methods, and so on, have been illustrated and described in considerable detail by describing examples, it is not the intention of the applicants to restrict or limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. This application is intended to embrace alterations, modifications, and variations that fall within the scope of the appended claims and thus the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. See, Bryan A. Gamer, A Dictionary of Modem Legal Usage 624 (2d. Ed. 1995).

1. A system configured to interact with a virtual bus interface that produces bus-type transactions from point-to-point transactions, the system comprising:
a detection logic configured to detect that a point-to-point transaction provided to the virtual bus interface is a non-implemented transaction for which no bus-type transaction should be produced and for which an error signal should be generated;
a tracking logic operably connected to the detection logic, the tracking logic being configured to facilitate tracking the point-to-point transaction as it is processed through one or more semantic phases by the virtual bus interface and to control the virtual bus interface to not produce a bus-type transaction associated with the non-implemented transaction; and
an error logic operably connected to the tracking logic, the error logic being configured to produce an error signal associated with one or more of, the non-implemented transaction being detected by the detection logic and the non-implemented transaction being tracked to completion by the tracking logic.

2. The system of claim 1, where the detection logic is configured to detect that a point-to-point transaction provided to the virtual bus interface is a non-implemented transaction by examining a packet type identifier in a header packet associated with the point-to-point transaction.

3. The system of claim 1, where the error logic is configured to produce, in response to detection logic detecting the non-implemented transaction, an error signal by updating one or more of, a value in a data structure associated with tracking the point-to-point transaction, and a value in a data store associated with tracking the point-to-point transaction.

4. The system of claim 1, where the error logic is configured to produce, in response to detection logic detecting the non-implemented transaction, an error signal by marking the point-to-point transaction with an error tag.

5. The system of claim 1, where the tracking logic is configured to examine a reusable transaction identifier provided by an initiating agent, where the reusable transaction identifier facilitates uniquely identifying the non-implemented transaction and a packet associated with the non-implemented transaction.

6. The system of claim 5, where the tracking logic is configured to release the transaction identifier allocated to a non-implemented transaction for reuse upon determining that the non-implemented transaction has been tracked to completion by the tracking logic.

7. The system of claim 1, where the detection logic is configured to compare a transaction identifier associated with the point-to-point transaction to a set of transaction identifiers to determine whether the point-to-point transaction has been previously identified as a non-implemented transaction.

8. The system of claim 1, where the detection logic is configured to receive an input data from a user, where the input data facilitates establishing a point-to-point transaction type as a non-implemented transaction.

9. A virtual bus interface system configured to selectively produce a bus-type transaction from a point-to-point type transaction, comprising:
a point-to-point transaction logic configured to receive a packet associated with a point-to-point transaction;
a detection logic configured to determine whether the packet is associated with a non-implemented transaction;
a bus-type transaction logic configured to selectively produce a bus-type transaction from the point-to-point transaction received by the point-to-point transaction logic;
a tracking logic configured to track a non-implemented transaction as it processed by the bus-type transaction logic; and
an error logic operably connected to the tracking logic and the detection logic, the error logic being configured to produce an error signal related to the non-implemented transaction, based, at least in part, on the determination made by the detection logic and the tracking performed by the tracking logic.

10. The system of claim 9, where upon determining that a point-to-point transaction is a non-implemented transaction, the detection logic stores in a data store a value that uniquely identifies the transaction, and where the error logic selectively controls the bus-type transaction logic based, at least in part, on the value.

11. The system of claim 10, where the error logic selectively controls the bus-type transaction logic to not produce a bus-type transaction from the point-to-point transaction.

12. The system of claim 10, where the tracking logic is configured to examine a reusable transaction identifier provided by an initiating agent, where the reusable transaction identifier facilitates uniquely identifying a non-implemented transaction, and where the tracking logic selectively controls the bus-type transaction logic to release the transaction identifier upon processing of the non-implemented transaction to completion.

13. The system of claim 9, where upon determining that a point-to-point transaction is a non-implemented transaction, the detection logic marks the point-to-point transaction as a non-implemented transaction, and where the error logic selectively controls the bus-type transaction logic based, at least in part, on the marking.

14. A method, comprising:
detecting a completion event associated with a point-to-point transaction being received in a virtual bus interface;
determining whether the point-to-point transaction is an implemented transaction;
selectively tracking the point-to-point transaction through the virtual bus interface as a non-implemented transaction; and
selectively producing an error data associated with a tracked non-implemented transaction.

15. The method of claim 14, including manipulating a memory location to identify the point-to-point transaction to the virtual bus interface as a non-implemented transaction.

16. The method of claim 14, including marking the point-to-point transaction to identify the point-to-point transaction to the virtual bus interface as a non-implemented transaction.

17. The method of claim 14, where determining whether the point-to-point transaction is an implemented transaction includes comparing a transaction identifier associated with the point-to-point transaction to a set of transaction identifiers previously identified as being associated with non-implemented transaction types.

18. The method of claim 14, where selectively tracking the point-to-point transaction through the virtual bus interface as a non-implemented transaction includes establishing a set of semantic phase completion criteria including an ultimate completion criteria and monitoring the progress of the point-to-point transaction through the set of semantic phase completion criteria to the ultimate completion criteria.

19. The method of claim 14, where selectively producing an error data associated with a tracked non-implemented transaction includes producing one or more of, an error signal, an error code, and an error message.

20. A computer-readable medium storing processor executable instructions operable to perform a method, the method comprising:
detecting a completion event associated with a point-to-point transaction being received in a virtual bus interface;
determining whether the point-to-point transaction is an implemented transaction by comparing a transaction identifier associated with the point-to-point transaction to a set of transaction identifiers previously identified as being associated with non-implemented transaction types;
selectively tracking the point-to-point transaction through the virtual bus interface as a non-implemented transaction by establishing a set of semantic phase completion criteria including an ultimate completion criteria and monitoring the progress of the point-to-point transaction through the set of semantic phase completion criteria to the ultimate completion criteria; and
selectively producing one or more of, an error signal, an error code, and an error message associated with processing a non-implemented transaction.

21. A system, comprising:
means for determining whether a packet associated with a point-to-point transaction received by a virtual bus interface identifies the point-to-point transaction as a non-implemented transaction;
means for identifying a packet associated with a non-implemented transaction to the virtual bus interface to facilitate processing a subsequently received packet associated with the non-implemented transaction; and
means for tracking the non-implemented transaction as it processed by the virtual bus interface.

22. A set of application programming interfaces embodied on a computer-readable medium for execution by a computer component in conjunction with handling a non-micro-architecturally implemented point-to-point link transaction presented to a virtual bus interface, comprising:
a first interface for communicating a point-to-point transaction;
a second interface for communicating a tracking data associated with tracking the point-to-point transaction as it processed by the virtual bus interface; and
a third interface for communicating an error data associated with reporting that a point-to-point transaction is a non-implemented transaction.
